(19) United States
(12) Patent Application Publication
(10) Pub. No.: US 2004/0237705 A1
(43) Pub. Date: Dec. 2, 2004

(54) Cover for a pedal

(76) Inventors: Patrick Rooney Conarro, Colorado Springs, CO (US); Richard Dean Soat, Colorado Springs, CO (US)

Correspondence Address: Dale B. Halling, Suite 311, 24 S. Weber St., Colorado Springs, CO, 80903, US

(21) Appl. No.: 10/727,126

(22) Filed: Dec. 3, 2003

Related U.S. Application Data
(60) Provisional application No. 60/464,316, filed on Apr. 21, 2003.

(51) Int. Cl. G05G 1/16

(52) U.S. Cl. 74/563

(57) ABSTRACT

A cover for a pedal has a substantially rectangular housing. An opening on a side of the substantially rectangular housing has a cross section having the approximate form of a pedal. An impression is formed on a top surface of the substantially rectangular housing.

### RELATED APPLICATIONS

The present invention claims priority on provisional patent application, Serial No. 60/464,316, filed on Apr. 21, 2003, entitled “Pedal Pads”.

### FIELD OF THE INVENTION

The present invention relates generally to the field of recreational devices and more particularly to the field of a cover for a pedal.

### BACKGROUND OF THE INVENTION

Pedals on bicycles or other devices commonly have a hard rough surface so that the user's shoe does not slip off the pedal. However, if the user is barefoot the rough hard surface is uncomfortable on the user's feet. Thus there exists a need for a cover for pedals that makes it comfortable for a user to pedal their bike or other recreational device in their bare feet.

### SUMMARY OF INVENTION

A cover for a pedal has a substantially rectangular housing. An opening on a side of the substantially rectangular housing has a cross section having the approximate form of a pedal. An impression is formed on a top surface of the substantially rectangular housing. In one embodiment, the substantially rectangular housing is formed of a durable foamed plastic material. The substantially rectangular housing has a number of rounded edges. In one embodiment, the substantially rectangular housing has a side opposite the opening that forms a three dimensional curve. In another embodiment, the opening has a pair of short walls, one of the pair of short walls has a bump. In another aspect of the invention, the opening has a pair of long walls, wherein one of the pair of long walls is V shaped. In one embodiment, the opening is butterfly shaped.

In one embodiment, an impression is formed on a bottom surface. The impression maybe a inverted dome. In one aspect of the invention, the impression is a partial footprint.

In one embodiment, a cover for a pedal has an exterior shape made of a flexible material. An opening on a side of the exterior shape has a substantially rectangular cross section. An impression is formed on a first surface of the exterior shape and on a second surface of the exterior shape. In one embodiment, the flexible material is a durable foam plastic. In another embodiment, the exterior shape has a mirror image plane that has a truncated elliptical cross section.

In one embodiment, the opening has a bulge. In one aspect of the invention, the impression is a reverse dome and a partial footprint on the reverse dome.

In one embodiment, a pedal cover has an exterior shape have a substantially planar side and a substantially partially spherical side. An opening is formed in the substantially planar side of the exterior shape. A partial footprint is formed in a side of the exterior shape. In one embodiment, the exterior shape has a mirror image plane.

In one embodiment, the opening has a pinched rectangular shape. The side of the exterior shape with the partial footprint has an inverted dome surface. In one embodiment, the partial footprint is a right footprint.

### BRIEF DESCRIPTION OF THE DRAWINGS

FIG. 1 is a perspective view of a cover for a pedal in accordance with one embodiment of the invention;

FIG. 2 is a side view of a cover for a pedal in accordance with one embodiment of the invention; and

FIG. 3 is a cross sectional view of a cover for a pedal along the A-A line of FIG. 2 in accordance with one embodiment of the invention.

### DETAILED DESCRIPTION OF THE DRAWINGS

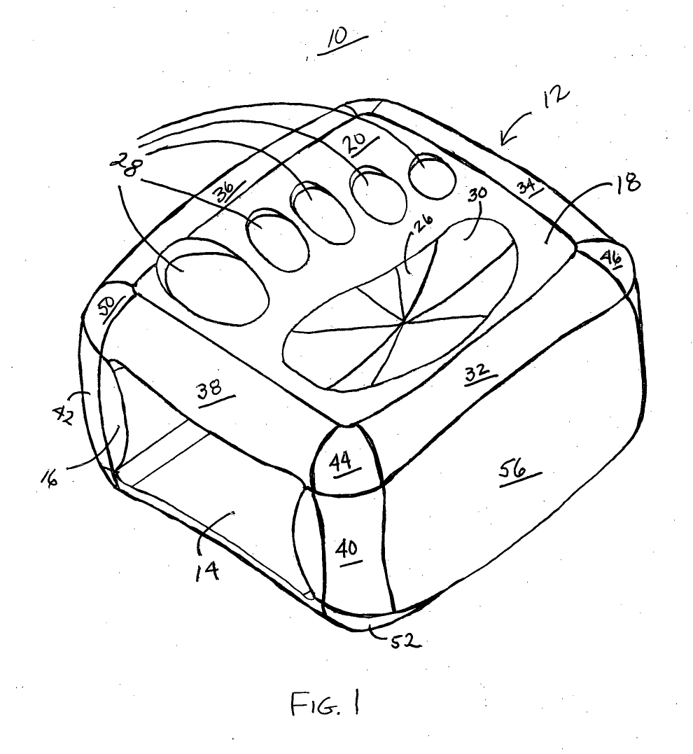

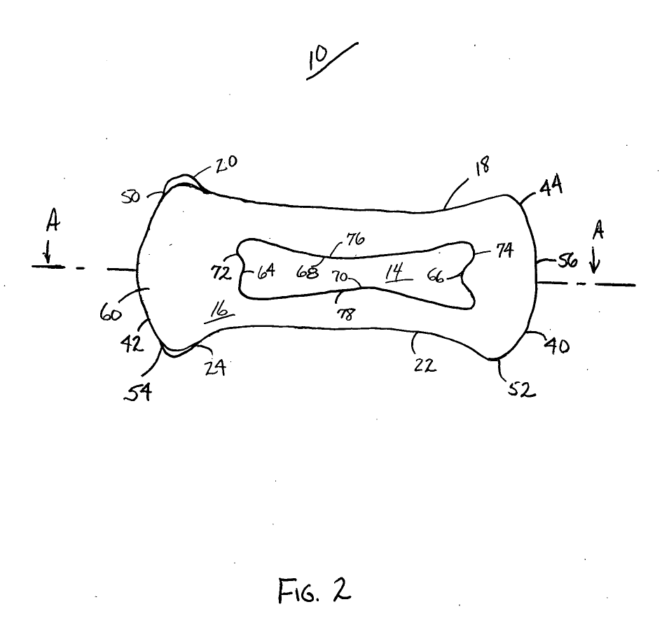

FIG. 1 is a perspective view of a cover 10 for a pedal in accordance with one embodiment of the invention. The cover 10 has a substantially rectangular housing or exterior shape 12. An opening 14 on a. substantially planar side 16 of the exterior shape 12 has a cross section having the approximate form of a pedal. The opening 14 is designed to fit snuggly over and encase most pedals. An impression 18 seen more clearly in FIG. 2 is formed on a top surface 20. A similar impression 22 is formed on the lower surface 24. Note that the designation of top and lower surface are arbitrary and only used for convenience of the description. Because the pedal normally is able to rotate, either surface may be the top or lower surface. The impressions 18, 22 are inverted or reverse dome shapes and may further include a partial impression of footprint (left or right foot) 26. As shown in FIG. 1 the partial footprint impression 26 includes the toes 28 and the ball of the foot 30. The impressions 18, 22 provide better grip for the user's feet.

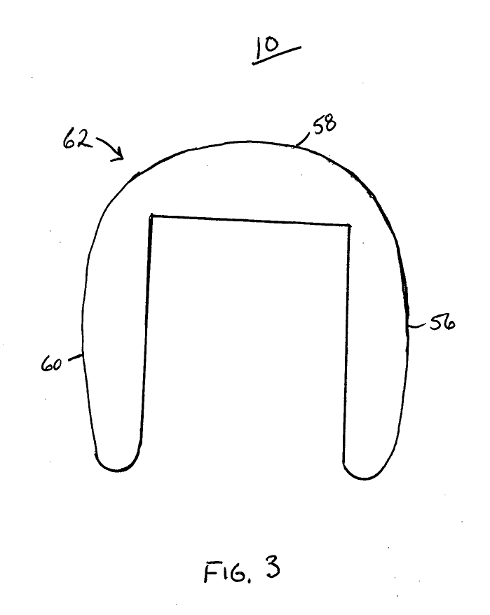

The cover 10 ideally is made of a flexible material that is comfortable to the barefoot. In one embodiment, the flexible material is a durable foamed plastic, such as foamed urethane. The exterior shape 12 is designed to have rounded edges 32 34, 36, 38, 40, 42 and rounded corners 44, 46, 48, 50, 52, 54. The rounded edges and corners provide two functions. One is that rounded edges are more durable and less likely to get caught on things and tear. The second function is that the rounded edges and corners provide a form for the plastic that is less likely to contain voids. This decreases the rejection rate for parts and therefore lowers the manufacturing costs for the covers. Not only are the edges and corners rounded, but the sides 56, 58, 60 are also rounded. This can be seen more clearly in FIGS. 2 & 3. This rounding results in these sides having a surface that is a three dimensional curve or substantially partially spherical sides. FIG. 3 is a cross sectional view of a cover for a pedal along the A-A line of FIG. 2 in accordance with one embodiment of the the invention. This shows that the cross section along the pseudo-mirror image plane A-A is a truncated elliptical shape 62. The rounding of the sides 56, 58, 60 provides the same advantages as rounding the edges and corners.

FIG. 2 is a side view of a cover 10 for a pedal in accordance with one embodiment of the invention. This view shows clearly that the opening 14 has a number of bulges or bumps 64, 66, 68, 70. These bumps give a butterfly shape to the cross section of the opening. The short walls 72, 74 have clear bulges 64, 66 while the long walls 76, 78 have a sort of V shape. This overall butterfly shape ensures that the cover 10 fits securely onto most pedal shapes and is able to accommodate most pedal shapes. Note that the cover complete encases the pedal and provides a cushioned surface around all sides of the pedal. This ensures that user's feet always encounter the cushioned material even if the pedal is out of position for their foot.

Thus there has been described a cover for a pedal that is durable, inexpensive to manufacture and makes pedaling in your bare feet a joy.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A cover for a pedal, comprising:
a substantially rectangular housing;
an opening on a side of the substantially rectangular housing having a cross section having the approximate form of a pedal; and
an impression on a top surface of the substantially rectangular housing.

2. The cover of claim 1, wherein the substantially rectangular housing is formed of a durable foamed plastic material.

3. The cover of claim 1, wherein the substantially rectangular housing has a plurality of rounded edges.

4. The cover of claim 1, wherein the substantially rectangular housing has a side opposite the opening that forms a three dimensional curve.

5. The cover of claim 1, wherein the opening has a pair of short walls, one of the pair of short walls having a bump.

6. The cover of claim 1, wherein the opening has a pair of long walls, wherein one of the pair of long walls is V shaped.

7. The cover of claim 1, wherein the opening is butterfly shaped.

8. The cover of claim 1, further including an impression on a bottom surface.

9. The cover of claim 1, wherein the impression is a inverted dome.

10. The cover of claim 1, wherein the impression is a partial footprint.

11. A cover for a pedal, comprising:
an exterior shape made of a flexible material;
an opening on a side of the exterior shape having a substantially rectangular cross section; and
an impression on a first surface of the exterior shape and on a second surface of the exterior shape.

12. The cover of claim 11, wherein the flexible material is a durable foam plastic.

13. The cover of claim 11, wherein the exterior shape has a mirror image plane that has a truncated elliptical cross section.

14. The cover of claim 11, wherein the opening has a bulge.

15. The cover of claim 11, wherein the impression is a reverse dome and a partial footprint on the reverse dome.

16. A pedal cover, comprising:
an exterior shape have a substantially planar side and a substantially partially spherical side;
an opening formed in the substantially planar side of the exterior shape; and
a partial footprint formed in a side of the exterior shape.

17. The pedal cover of claim 16, wherein the exterior shape has a mirror image plane.

18. The pedal cover of claim 17, wherein the opening has a pinched rectangular shape.

19. The pedal cover of claim 18, wherein the side of the exterior shape with the partial footprint has an inverted dome surface.

20. The pedal cover of claim 16, wherein the partial footprint is a right footprint.
